(19) United States
(12) Patent Application Publication
(10) Pub. No.: US 2015/0302942 A1
(43) Pub. Date: Oct. 22, 2015

(54) OXIDE NUCLEAR FUEL WHICH IS A REGULATOR OF CORROSIVE FISSION PRODUCTS, ADDITIVATED WITH AT LEAST ONE OXIDATION-REDUCTION SYSTEM

(71) Applicant: COMMISSARIAT A L'ENERGIE ATOMIQUE ET AUX ENERGIES ALTERNATIVES, Paris (FR)

(72) Inventors: Chantal Riglet-Martial, Le Tholonet (FR); Méryl Brothier, Aix En Provence (FR); Pierre Matheron, Manosque (FR); Vanessa Pennisi, Aix En Provence (FR); Virginie Basini, Pierrevert (FR)

(21) Appl. No.: 14/441,113

(22) PCT Filed: Nov. 8, 2013
(86) PCT No.: PCT/EP2013/073374

§ 371 Date: May 6, 2015

(30) Foreign Application Priority Data
Nov. 8, 2012 (FR) 1260616

(51) Int. Cl. G21C 3/62; G21C 21/02; G21C 3/06

(52) U.S. Cl. CPC G21C 3/623; G21C 3/06; G21C 21/02

(57) ABSTRACT

A supplemented nuclear fuel comprises a nuclear fuel of oxide type which generates fission products such as tellurium, cesium and iodine, which generate via chemical interaction species that are potentially corrosive, supplemented with at least one redox system comprising a first and second species comprising a common element having a different degree of oxidation in each of the two species, the system having an oxygen potential curve as a function of the temperature that is within an interval delimited by:
an upper limit: the curve of coexistence of the chemical species I₂Te (g) and CsI (g) at the same partial pressure imposed by the equilibrium between CsI (l) and CsI (g), approximated between 1000° C. and 2000° C. by a straight line segment whose ends P_{O2/11} and P_{O2/12} have the coordinates:
P_{O2/11} (T=1000° C.)≈−370 kJ/molO₂ and
P_{O2/12} (T=2000° C.)≈−230 kJ/molO₂; and
a lower limit: the curve of oxygen potential of the system (Cs₂MoO₄/Cs+Mo) approximated between 1000° C. and 2000° C. by a straight line segment whose ends P_{O2/21} and P_{O2/22} have the coordinates:
P_{O2/21} (T=1000° C.)≈−530 kJ/molO₂ and
P_{O2/22} (T=2000° C.)≈−390 kJ/molO₂.

The field of the invention is that of nuclear fuels and notably of nuclear fuels that minimize the effects of corrosion in fuel rods during functioning.

In general, a nuclear fuel may be defined as a material that contains fissile actinide cores that are the source of the fission reactions. This material may be in various forms (pure metal, metal alloys, various ceramics—oxide, carbide, nitride, mixtures of ceramic and of metal, mixtures of various ceramics, or even liquid, in the very particular case of molten salt reactors). This material is enclosed in a leaktight container, often referred to as the fuel cladding.

In order to improve the behavior during normal and/or incidental functioning and also the service life of nuclear fuels, modifications have been sought to the fuel and/or the cladding that constitutes its first confinement barrier. These modifications are usually directed more particularly toward a function to be improved, whether this is with regard to the retention of the fission products (FP) inevitably generated during the use of the fuels in a reactor, or whether it is regarding the minimization of the chemical and mechanical interactions at the interface between the constituent pellets of the fuel and the cladding (Pellet-Clad Interactions, PCI risk).

In general, during the use of oxide-type nuclear fuel in a reactor, the fissile material is subjected to fission reactions that give rise to chemical species known as fission products (FP), on the one hand, and release oxygen, on the other hand. Certain FPs are chemically unreactive, such as rare gases, denoted RG (Xe, He, Kr, etc.), whereas others combine with the oxygen released in the form of independent phases or as a solid solution in the fuel, or alternatively combine to form “volatile gases”, denoted VG (iodine, tellurium or cesium species), which are liable to migrate into the free volume present between the fuel and the cladding enclosing it. This phenomenon leads to the generation of gas and is gradually accompanied, as the degree of combustion of the fuel increases, by an increase in the oxygen potential in the material, notably since certain fission products have less affinity (such as platinoids) for the oxygen initially bonded to the fissile and/or fissible atoms (uranium, Pu, Th, etc.) constituting the fuel. Moreover, power transients induce large temperature gradients which considerably modify the oxygen potential locally in the material and thereby the chemical equilibria of the fission products, notably in gaseous form.

This twofold tendency (large variation in the oxygen potential and in the pressure of gas within the cladding containing the fuel) induces thermodynamic runaway conditions within the system delimited by the internal space of the cladding throughout the duration of use of the fuel, and all the more so when the degree of combustion is high and when the power variations are large. In this sense, the thermomechanical properties (heat conductivity, creep properties, etc.) of the fuel (which are dependent both on the temperature conditions and on the oxygen potential) are no longer controlled either, but rather endured as a function of the evolution induced by the degree of combustion and the mode of functioning. Moreover, this effect is concomitant with another that is associated with the increase in gas pressure in the volume left free between the fuel and the cladding, which induces mechanical constraints thereon (which may lead to swelling).

An increased radiological risk should also be noted, since gaseous fission products potentially have an appreciable impact on the environment in the event of rupture of the confinement barrier (cladding). Finally, certain gaseous species generated during the use of the fuel in a reactor may lead to corrosion of the cladding, the thermodynamic conditions prevailing in the material possibly leading to speciations that are unfavorable with respect to corrosion (preexistence of corrosive species).

For all these reasons, it is sought to implement means for preventing the harmful phenomena described or for limiting the consequences thereof. The prior art that follows presents the main categories of known means and demonstrates the fact that these means globally do not entirely satisfactorily address the abovementioned problem.

Finally, it should be noted that another type of difficulty may be encountered, which is once again associated with controlling the oxygen potential, and concerning the manufacture of the fuel itself. The type of fuel targeted by the present invention and the manner in which it is developed make it possible to address this need for/interest in controlling the oxygen potential, which has a substantial impact on the sintering behavior of the fuel and its final characteristics/properties after this sintering step.

At the present time and conventionally, the partial pressure of oxygen, denoted P_{O2}, in the fuel-cladding system is imposed spontaneously by the fission occurring during the use of the fuel in a reactor. In this sense, this P_{O2} is notably dependent on the degree of combustion, which does not allow control of the behavior of the fuel-cladding system during its use (with a potential absence of control of its physical and microstructural properties).

This absence of control of the P_{O2} moreover does not make it possible to control the speciation of the species within the system and consequently certain compounds have a negative impact on the system (with regard to the pressure increase or corrosion of the cladding, notably) may naturally be generated during fission (for instance the compound TeI₂).

Several types of improvement have been envisaged for limiting the impact of the fission products (FP) emitted during the use of nuclear fuel in a reactor with regard to the constraint induced by the PCI or to increase the retention of these FPs within the fuel.

These improvements may be classified in the following two major families:

1) Fuels with a Modified Pellet-Clad Interface:

1.1: Use of a Getter-Type Trapping Material:

A certain number of solutions based on the use of an agent allowing the (chemical) trapping of certain FP species, or even of oxygen, are claimed in the literature, notably as in patent applications EP 0 541 458 A1 or EP 0 508 715 A1.

However, these solutions, as a whole, do not make it possible to limit, as far as possible, the generation of gaseous and corrosive species, which leads to the persistence of detrimental local phenomena (notably with the modification in the microstructure of the fuel itself). Getter materials are not necessarily efficient over a wide temperature range such as that which may be imposed on a fuel during normal or incidental functioning.

1.2: Protection of the Cladding by Using a Lining or Even a Sheath on the Pellets Themselves:

This type of solution such as those described in patents EP 0 562 404 A3, U.S. Pat. No. 4,022,662, U.S. Pat. No. 4,029,545 or U.S. Pat. No. 4,025,288 proposing the insertion of a sheet, layer or multilayer of materials acting as a screen to the interaction between certain fission products and the cladding, is of entirely relative efficacy since either it is of selective efficacy (with regard to certain species) or it is subject to harmful phenomena induced notably by inter-diffusion under irradiation, amorphization or differential expansions leading to a deterioration in the expected properties of the cladding as a whole (notably mechanical strength and good global heat conductivity).

Moreover, the insertion of such a screen into narrow cladding such as that constituting fuel assemblies may represent a technical difficulty or, at the least, a constraint that is occasionally prohibitive from an industrial viewpoint. Ensuring the homogeneity of the deposit over the entire internal surface of the cladding is non-trivial or even not acquired in some cases, which renders this type of solution far from satisfactory.

2) Supplemented Fuels:

2.1: Trapping/Uptake of Particularly Reactive FPs in the PCI Process:

Solutions of this type are based on the incorporation of an additive or a mixture into the fuel itself to act as a “getter” as described, for example, in patent CA 977 952. In this type of solution, the additives are compounds that are reactive toward FPs, enabling destabilization of the corrosive gaseous species to the benefit of the production of others that are uncorrosive or less so. It should be noted that the targeted amount of these additives in order to be effective are relatively large since they may be up to 4% by mass. These additives may, in certain cases, also act as dopant for the growth of grains. However, as mentioned previously, the additives as described in the literature do not entirely satisfy the general problem stated for a broad temperature range and high degree of combustion values.

2.2: Fuel with Improved Microstructure (which May be Combined with the “Imposed Oxygen Potential” Solution):

One of the means put forward for minimizing and/or retarding the emission of gaseous fission products is the use of large-grain fuel. Specifically, this type of microstructure increases the mean travel time of FPs before they exit the fuel material (notably due to the coefficient of intra-granular diffusion of the FPs in the fuel which is less than the coefficient of inter-granular diffusion). This type of strategy is described notably in patents JP 2 655 908 (B2) and US 2010/091933. They describe the incorporation of additives (which may be Gd and Cr).

Nevertheless, the incorporation of certain elements has an impact on the coefficient of diffusion of FPs in the fuel. The choice of additives is therefore not trivial. It should be noted that the dopants proposed are generally metals or even oxides such as those illustrated in patent FR 2 817 385. The difficulty in using this type of solution also lies in the fact that it is not particularly easy to control the oxygen potential during the development of the fuel, which renders the control of its manufacture sparingly robust (notably during the sintering step) and thus also the control of its microstructure (the oxygen potential depending not only on the temperature but also the atmosphere imposed in the sintering oven).

The fuel obtained with this type of solution or others specifically intended to be capable of controlling the oxygen potential by incorporation of dopants (without necessarily entailing an effect of increasing the grain size) does not in fact allow (as notably described in patent JP 6 258 477 A) strict control of the oxygen potential within an optimized range in order, on the one hand, to improve the sequestration of the FPs and, on the other hand, to control the speciation, so as advantageously to limit the corrosive species over a wide temperature range and degree of combustion. It therefore does not globally satisfy the abovementioned general problem.

For example, in the abovementioned patent JP 625 8477 A, the addition of molybdenum is used as a “getter”, i.e. an oxygen consumer according to the reaction Mo+O₂=>MoO₂ in order to overcome the increase in the content of free oxygen with the degree of combustion. The argument regarding controlling the oxygen potential given in the patent is then indirect, the buffer acting as a result of the presence during functioning of MoO₂ and Mo.

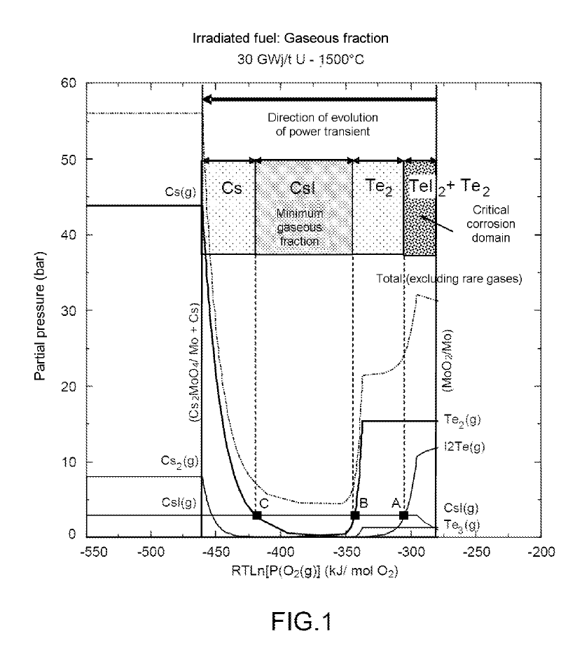

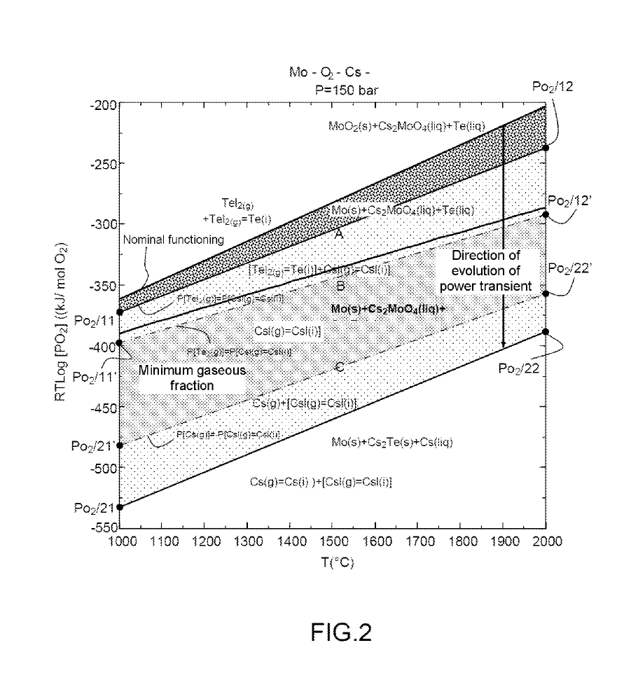

In patent JP 625 8477 A, if the buffer capacity necessary in oxidation is dimensioned to trap the excess oxygen, the buffer capacity in reduction is, on the other hand, not taken into consideration. It should be noted that the value of the oxygen potential imposed by the redox equilibrium (MoO₂/Mo) is not optimized either with regard to the volatile gases since it is within the range of predominance of the corrosive form TeI₂, as illustrated in FIG. 1 and in FIG. 2, developed by the Applicant, which show, respectively, the evolution of the partial pressure and speciation profile in a standard UO₂ fuel irradiated at 30 GWj/t U at 1500° C. as a function of the oxygen potential during functioning and the range of predominance of the major volatile fission products (excluding He and Xe) in a standard UO₂ fuel, as a function of the temperature and of the oxygen potential during functioning.

More precisely, it emerges that, during nominal functioning, the oxygen potential is imposed by the redox couple (MoO₂/Mo). In power ramp, the fuel undergoes at the core a reductive perturbation during which the oxygen potential decreases to the buffer potential of the system (Cs₂MoO₄/Mo+Cs).

In the range of variation of the oxygen potential, the speciation of the volatile fission gases, which is a function of the P_{O2}, evolves. The interval is divided into 4 domains successively corresponding to the predominance of the gases TeI₂+Te₂, Te₂, CsI and Cs.

Iodine is predominantly present in the forms TeI₂ and/or CsI. Since the form TeI₂ is the most corrosive with respect to zircaloy, the constituent material of the cladding, the “TeI₂+Te₂” domain corresponds to the most critical potential zone with regard to corrosion of the cladding. The intermediate domain of predominance of the CsI form alone ([BC] interval of FIG. 1) corresponds to the potential zone in which the gaseous fraction of corrosive gases is minimal (maximum immobilization of the FPs), which is favorable to limiting the release of the gases.

Moreover, in the functioning domain of the fuel, between the buffer systems (MoO₂/Mo) and (Cs₂MoO₄/Mo+Cs), the speciation of the gases varies as a function of the P_{O2} (as illustrated in FIG. 1) and of the temperature. Thus, the limits of the domains of predominance are materialized in FIG. 2 at any temperature by points A, B, C of FIG. 1, corresponding to the P_{O2} conditions for which the partial pressure of the gases present, respectively I₂Te (g), Te₂ (g) and Cs (g), is equal to that of the gas CsI denoted CsI (g), imposed by the equilibrium with CsI in liquid form, denoted CsI (l). In an oxidative medium, there is a functioning range in which the corrosive form TeI₂, which is potentially reactive toward the zircaloy cladding, is predominant over the entire temperature range between 1000 and 2000° C.

The zone in which the gaseous fraction is minimal (composed predominantly of CsI (g)) is surrounded by two zones in which Te_{2(g)} (oxidative side) or Cs_{(g)} (reductive side) predominate. This is why the Applicant considered that the use of a “buffer” redox system is particularly advantageous for keeping the fuel in an optimum functioning range with regard to the FGs (in medium gray) at any moment, and in a context in which the abovementioned prior art solutions do not, as a whole, allow optimized control of the oxygen potential, over a wide temperature range (typically 400-2000° C.). The reason for this is that some of these solutions consisting in adding oxidative additives are rather directed toward modifying the microstructure or inducing passivation of the cladding by supplying an excess of oxygen, which is a competitor of certain corrosive species toward the constituent material of the cladding. These solutions are often based on the addition of an element in fairly large amount (up to more than 5% by weight of molybdenum, described in patent JP 6 258 477 A). Finally, it should be noted that the addition of an additive in only one degree of oxidation, as is proposed by all of the solutions identified in the prior art, does not make it possible to P_{O2} buffer the fuel and its close environment during its manufacture.

It is thus seen that no solution making it possible, by addition of elements, to maintain in an optimized value range the oxygen potential of the fuel (typically 400° C.-2000° C.), i.e. not only over a wide functioning temperature range in a reactor, of degree of combustion and of mode of functioning, but also during the manufacture of the fuel itself, has been described to date.

More precisely, the Applicant proposes a solution for controlling the oxygen potential, during normal and/or incidental functioning, which is an important parameter for improving the performance qualities of the fuel. The reason for this is that the oxygen potential has an influence on several properties such as the heat conductivity, the release of fission gases, the creep behavior and the speciation of the fission gases that are corrosive to the cladding. Controlling the oxygen potential during functioning makes it possible to control and to improve the performance qualities of the fuel.

In the absence of doping of the fuel with a suitable redox system, the fission reactions that take place within the fuel naturally impose a point of functioning controlled by the MoO₂/Mo couple that is within the domain of predominance of the form TeI₂ that is potentially corrosive toward the constituent material of the cladding (of Zircaloy type).

The present invention thus proposes to incorporate an additive into the nuclear fuel making it possible to buffer the oxygen potential during functioning of said fuel in a stable and durable manner (even for high degrees of combustion) in a potential range in which, notably, the corrosive form TeI₂ is absent since it is destabilized at the benefit of the uncorrosive species CsI.

One subject of the invention is thus a supplemented nuclear fuel, comprising a nuclear fuel of oxide type which generates fission products such as tellurium, cesium and iodine, which generate via chemical interaction species that are potentially corrosive, characterized in that it is supplemented with at least one redox system comprising a first and a second species comprising a common element having a different degree of oxidation in each of the two species, said system having an oxygen potential curve as a function of the temperature that is within an interval delimited by:

an upper limit: the curve of coexistence of the chemical species I₂Te (g) and CsI (g) at the same partial pressure imposed by the equilibrium between CsI (l) and CsI (g), approximated between 1000° C. and 2000° C. by a straight line segment whose ends P_{O2/11} and P_{O2/12} have the coordinates:

P_{O2/11} (T=1000° C.)≈−370 kJ/molO₂ and

P_{O2/12} (T=2000° C.)≈−230 kJ/molO₂;

a lower limit: the curve of oxygen potential of the system (Cs₂MoO₄/Cs+Mo) approximated between 1000° C. and 2000° C. by a straight line segment whose ends P_{O2/21} and P_{O2/22} have the coordinates:

P_{O2/21} (T=1000° C.)≈−530 kJ/molO₂ and

P_{O2/22} (T=2000° C.)≈−390 kJ/molO₂;

said curves define an interval in which the volatile gases generated by fission are stabilized in chemical forms that are not corrosive toward the material (for example zircaloy) constituting the cladding, for degrees of combustion of less than about 60 GWj/t.U (tons of uranium).

The system may have a curve of oxygen potential as a function of the temperature that is in an interval defined by a sub-domain delimited by:

an upper limit: the curve of coexistence of the chemical species Te₂ (g) and CsI (g) at the same partial pressure imposed by the equilibrium between CsI (l) and CsI (g), approximated between 1000° C. and 2000° C. by a straight line segment whose ends P_{O2/21′} and P_{O2/22′} have the coordinates:

P_{O2/11′} (T=1000° C.)≈−395 kJ/molO₂ and

P_{O2/12′} (T=2000° C.)≈−290 kJ/molO₂;

a lower limit: the curve of coexistence of the chemical species Cs (g) and CsI (g) at the same partial pressure imposed by the equilibrium between CsI (l) and CsI (g), approximated between 1000° C. and 2000° C. by a straight line segment whose ends P_{O2/21′} and P_{O2/22′} have the coordinates:

P_{O2/21′} (T=1000° C.)≈−480 kJ/molO₂ and

P_{O2/22′} (T=2000° C.)≈−360 kJ/molO₂,

said curves defining a sub-interval in which the gaseous fraction of the volatile gases generated by fission is both non-corrosive and minimal, for degrees of combustion of less than or equal to about 70 GWj/tU and preferentially less than about 60 GWj/t.U (tons of uranium).

For the rare gases (RG) such as Xe, Kr, etc., which are chemically unreactive, the partial pressure evolves to a first approximation according to the ideal gas law:

P=nRT/V, showing a change in pressure (P) as a function of the number of mols (n) dependent on the degree of combustion, the volume (V) and the temperature (T) and R: ideal gas constant.

For chemically reactive volatile gases (VG) (such as Cs, I, Te), although their elementary amounts increase as the degree of combustion increases, their partial pressures are imposed at any instant by the solid-liquid-gas equilibria as:

CsI (g)=CsI (s,l),Teₓ (g)=Te (l),

TeI₂+Cs₂MoO₄=Te (l)+2CsI (s,l)+Mo (s)+O₂ . . . , (s, l and g being relative to the solid, liquid and gas species).

The constants of these thermodynamic equilibria, which impose the partial pressures of the various gases, are dependent only on the temperature and the partial pressure of oxygen. They are not dependent either on the free volume or on the degree of combustion as long as the chemical system remains unchanged, i.e. as long as certain fission or activation products generated in the reactor remain in sufficiently low amount so as not to perturb the chemical system under consideration.

Thus, FIG. 1 was constructed from a calculation on the basis of a degree of combustion of 30 GWj/t.U, so as to keep the free volume constant (which is variable as a function of the degree of combustion), which has an effect on the partial pressure of the rare gases (RG). On the other hand, the degree of combustion has no effect on the partial pressures of the volatile gases (VG) at least up to 60 GWj/t.U.

The Applicant thus took the preceding hypotheses into consideration for constructing the curves of oxygen potential as a function of the temperature in the context of degrees of combustion of less than about 60 GWj/t.U. Beyond such a degree of combustion, the chemistry of the chemical system becomes considerably more complex due to the large density of products generated by the reaction.

According to the present invention, control of the oxygen potential is ensured by a redox buffer system, which is characterized by the coexistence of two phases, one oxidized and the other reduced. The choice of the redox system is greatly conditioned by the P_{O2} value to be achieved. In the case of the present invention, a P_{O2} domain is targeted such that the presence of corrosive species is minimal, over a wide temperature range (typically between 400° C.-2000° C.) and for significant degrees of combustion that may typically be up to 30 GWj/t.U, by controlling the P_{O2} in this range to be favored with regard to the abovementioned general problem.

Further, the Applicant has identified fuel formulations with a self-regulated oxygen potential which satisfy the following concomitant conditions with regard to the additive(s) to be used:
additives that do not induce any excessive industrial manufacturing technological constraint;
additives which induce a redox buffer capacity sufficient to maintain the oxygen potential in the optimum range targeted with regard to the abovementioned general problem (in terms of temperature range, degree of combustion, etc.). The optimum oxygen potential targeted should allow minimization of the gaseous fraction of species containing Cs, I, Te and should notably avoid the formation of the corrosive species TeI₂;
additives that do not modify in an excessively penalizing manner the physicochemical properties of the fuel (notably its heat conductivity, its creep behavior, its melting point, its densification, etc.) and its ability to be recycled;
additives that advantageously induce grain growth of the fuel, where appropriate.

According to one variant of the invention, at least one of the two species comprises an element derived from fission products that may be:
molybdenum, said system comprising a couple of the type such as: XMoO₄/XO in which X belongs to the alkaline-earth family (Ba, Ca, Sr);
barium, said system comprising the BaUO₄/BaO couple.

According to one variant of the invention, the redox system comprises at least one of the following couples:
TiO₂/Ti₄O₇;
Ti₄O₇/Ti₃O₅;
V₂O₃/VO;
Ga₂O₃/Ga;
Cr₂O₃/Cr;
Cr₂O₃/CrO;
CrO/Cr;
Nb₂O_{5/2}/NbO₂;
NbO₂/NbO;
Nb₂O_{5/2}/NbO₂/NbO.

According to one variant of the invention, the fuel comprises a mass percentage of first species and a mass percentage of second species that is within about a few tenths and a few percent relative to the fissible nuclear fuel.

According to one variant of the invention, the amounts of oxidizing agent and of reducing agent incorporated into the fuel are equimolar.

According to one variant of the invention, the redox system comprises a mixed system based on NbO_{5/2}/NbO₂, the amount of NbO₂ being greater than that of NbO_{5/2}.

A subject of the invention is also a combustible element comprising a nuclear fuel according to the invention and cladding containing the nuclear fuel.

A subject of the invention is also a process for manufacturing a tablet comprising the supplemented nuclear fuel according to the invention, characterized in that it comprises the following steps:
a step of mixing the powders of fissible nuclear fuel that may be UO₂ and of the redox system;
a step of mechanical granulation of the mixture by pressing at low pressure which may be between about 50 MPa and 100 MPa;
a step of forming by pressing at a higher pressure that may be between about 300 MPa and 700 MPa;
a step of sintering under a reductive and/or neutral atmosphere at a temperature that may be about 1700° C.

According to one variant of the invention, the powder mixing step is performed by comilling in dry or liquid medium.

According to one variant of the invention, the powder mixing step is performed in a turbomixer.

According to one variant of the invention, the sintering step is performed with a temperature increase protocol comprising two temperature ramps separated by a temperature steady at about 300° C., followed by a stage at a temperature of about 1700° C.

According to one variant of the invention, the sintering step is performed in an oven in the presence of an additional amount of redox system.

A subject of the invention is also a process for manufacturing a nuclear reactor fuel element comprising cladding and a supplemented nuclear fuel, characterized in that it comprises the process steps for manufacturing a tablet comprising said supplemented nuclear fuel, according to the invention.

The invention will be understood more clearly and other advantages will emerge on reading the description that follows, which is given on a nonlimiting basis and by means of the attached figures, among which:

FIG. 1 illustrates the partial pressure and speciation profiles of the FGs (excluding He and Xe) in a standard UO₂ fuel irradiated at 30 GWj/t.U, at 1500° C. as a function of the functioning oxygen potential;

FIG. 2 illustrates the range of predominance of the major volatile fission products (excluding He and Xe) in a standard UO₂ fuel, as a function of the functioning temperature and oxygen potential;

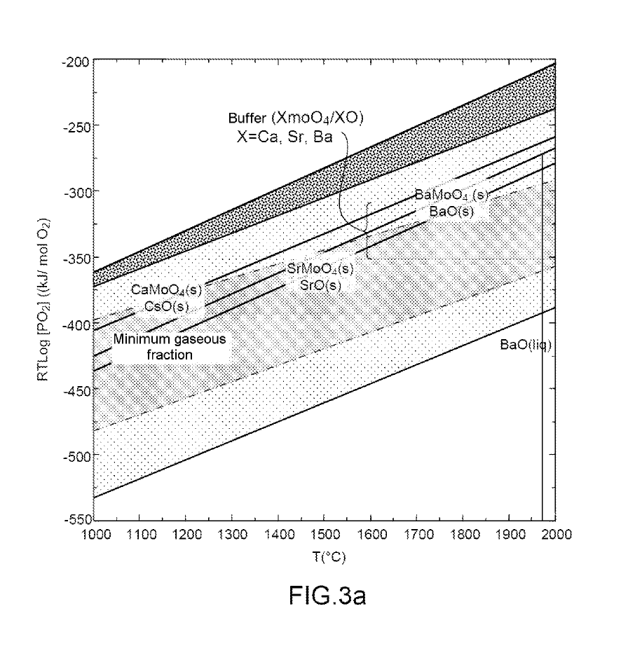

FIGS. 3a and 3b illustrate, respectively, the position of XMoO₄/XO and BaUO₄/BaO redox buffer systems capable of buffering the P_{O2} in the fuel functioning range, relative to the stability zones of the volatile fission products;

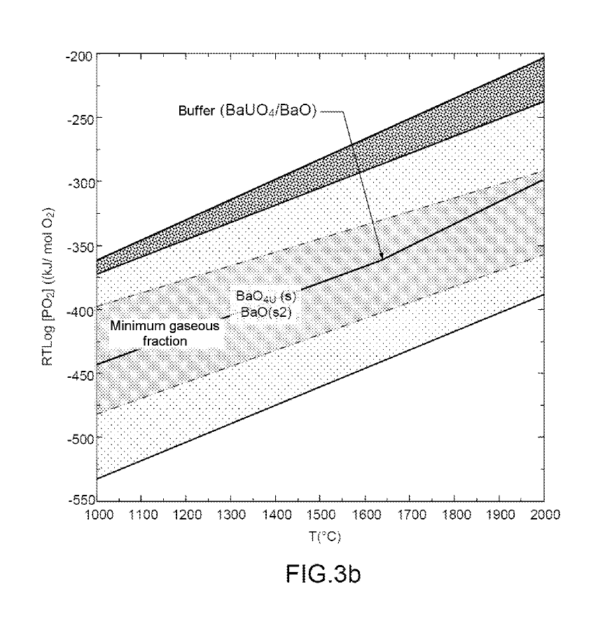

FIG. 4 illustrates the position of a Ti—O redox buffer system capable of buffering the P_{O2} in the fuel functioning range, relative to the stability zones of the volatile fission products;

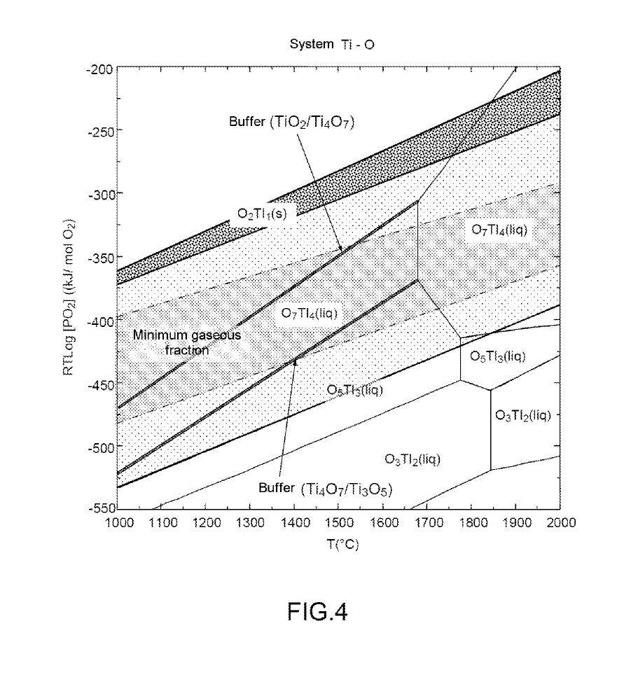

FIG. 5 illustrates the position of the V—O redox buffer system capable of buffering the P_{O2} in the fuel functioning range, relative to the stability zones of the volatile fission products;

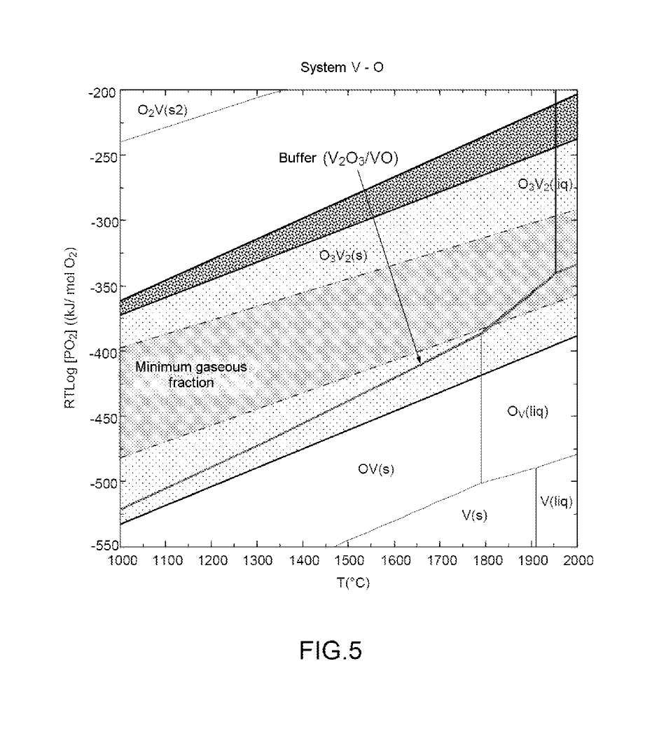

FIG. 6 illustrates the position of the Ga—O redox buffer system capable of buffering the P_{O2} in the fuel functioning range, relative to the stability zones of the volatile fission products;

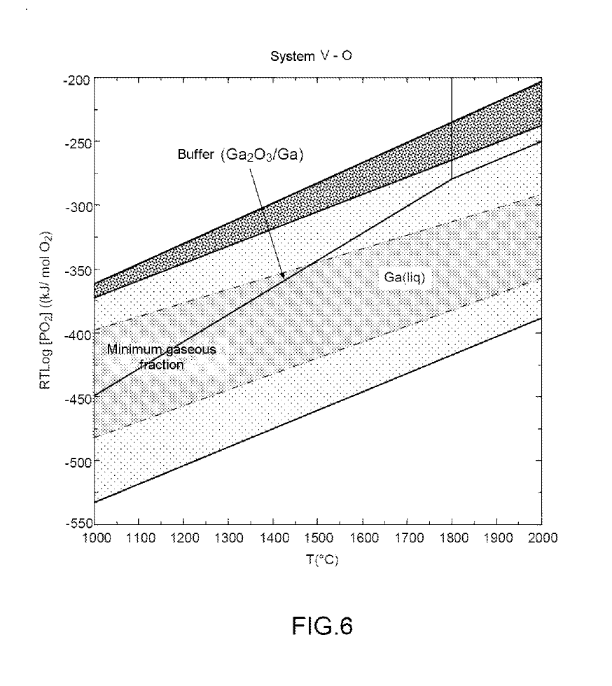

FIG. 7 illustrates the position of the Cr—O redox buffer system capable of buffering the P_{O2} in the fuel functioning range, relative to the stability zones of the volatile fission products;

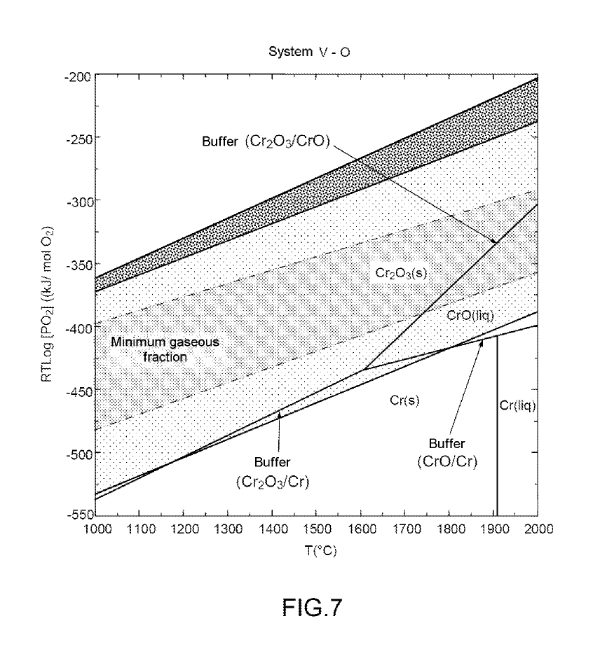

FIG. 8 illustrates the position of the Nb—O redox buffer system capable of buffering the P_{O2} in the fuel functioning range, relative to the stability zones of the volatile fission products;

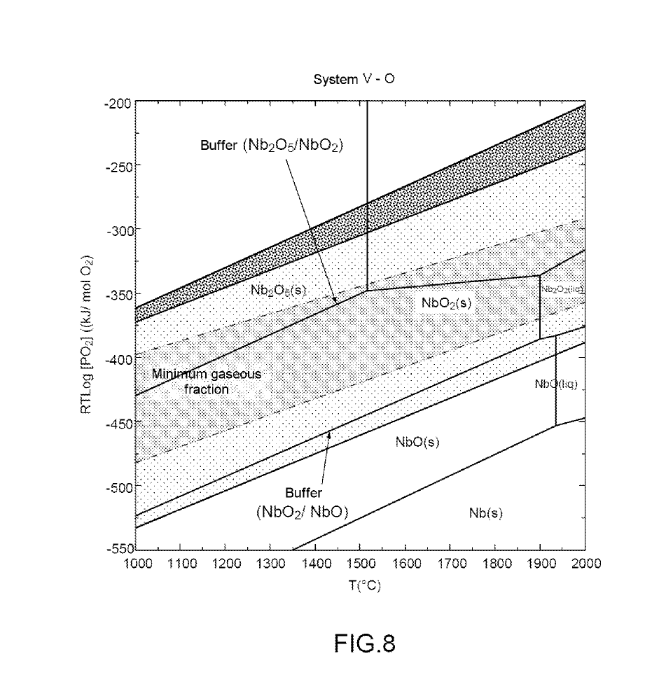

FIG. 9 illustrates an example of a temperature cycle that may be used in a sintering operation during the manufacture of an object comprising a supplemented fuel of the invention;

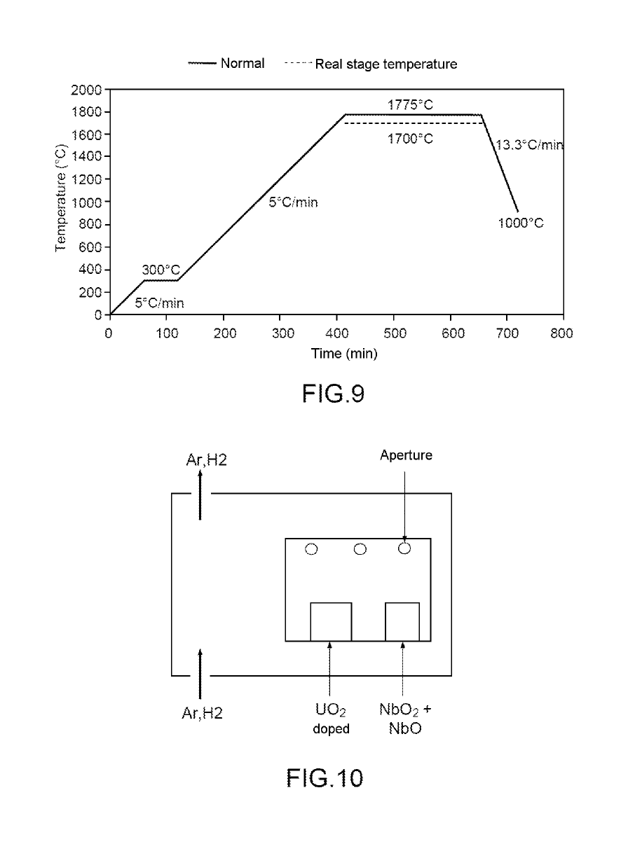

FIG. 10 illustrates an example of a sintering device (itself placed in an oven) for producing pellets comprising a supplemented fuel of the invention.

A subject of the present invention is thus a family of functional fuels for improving the behavior of the fuel in a reactor when compared with the fuels known in the prior art as regards their properties for controlling and regulating the oxygen potential of the fuel system/FPs generated in a reactor.

Thus, according to the present invention, control of the oxygen potential is ensured by a redox buffer system, which is characterized by the coexistence of two phases, one oxidized and the other reduced. The choice of the redox system is greatly conditioned by the evolution of its oxidation potential RT log PO₂ as a function of the temperature, in a favorable redox potential range, defined by the oxygen potentials illustrated in FIG. 2, namely located between:

a first curve of oxygen potential, expressed in kJ/mol O₂, as a function of the temperature, approximated by a straight line segment whose ends have the coordinates:

P_{O2/11} (T=1000° C.)≈−370 kJ/mol O₂ and

P_{O2/12} (T=2000° C.)≈−250 kJ/mol O₂;

a second curve of oxygen potential, expressed in kJ/mol O₂, as a function of the temperature, approximated by a straight line segment whose ends have the coordinates:

P_{O2/21} (T=1000° C.)≈−530 kJ/mol O₂ and

P_{O2/22} (T=2000° C.)≈−410 kJ/mol O₂.

In this range, defined between the two straight line segments [P_{O2/11}, P_{O2/12}] and [P_{O2/21}, P_{O2/22}], the volatile gases generated by fission are stabilized in chemical forms that are not corrosive toward the zircaloy constituting the cladding, and this being the case for significant degrees of combustion (at least 30 GWj/t.U (tons of uranium)).

In parallel, it should be noted that the methods for producing these fuels, mentioned in the present invention, are also found to be notably improved since the material is capable of buffering in situ the sintering oxygen potential, which is a parameter substantially governing the properties and characteristics of the finished product.

The redox buffer systems under consideration are all reactive in a temperature range of between 500 and 2000° C., over an interval that is variable as a function of the redox couples.

The predominance diagrams presented below clearly illustrate that the oxygen potential of these redox couples totally or partially fall within the optimal oxygen potential zone as described previously and illustrated by means of FIGS. 1 and 2 (minimization of the gaseous fraction and absence of a highly corrosive species such as TeI₂).

FIGS. 3a and 3b illustrate the cases of the systems (Ba, Ca, Sr)—Mo—O and Ba—U—O:

The barium (or Sr or even Ca) buffer systems (X—Mo—O₄ or X—U—O₄:XO) are capable of buffering the P_{O2} in the fuel functioning domain, over the entire temperature range between 1000 and 2000° C. These chemical compounds, naturally generated by the uranium fission products, are thus capable of participating in the regulation of O₂ if the fuel is subjected to a reductive perturbation; the (Ba—U—O₄/Ba—O) system is active throughout the zone in which the gaseous fraction is minimal between 1000 and 2000° C.; the working buffer capacity of the (X—Mo—O₄, X—O) systems is 3 mol O/mol X (if Mo is in excess). That of the (Ba—U—O₄/Ba—O) system is 1 mol O/mol Ba.

FIG. 4 illustrates the cases of the Ti—O system:

The Ti—O system has multiple polymer phases in which the degree of oxidation of the titanium varies from +4 to +3; at a temperature below 1700° C., only two titanium buffer systems are capable of buffering the P_{O2} in the fuel functioning domain. The maximum working buffer capacity is ⅓ mol O/mol Ti. Beyond 1700° C., the liquid phase Ti₄O₇ predominates throughout the domain of interest.

FIG. 5 illustrates the case of the V—O system:

The (V₂O₃/VO) redox system of vanadium is rather located in the reductive zone of the fuel functioning domain. The (V₂O₃/VO) system is active in the minimum gas zone at high temperatures (above 1800° C.). The VO₍ₗ₎) liquid phase appears in the region of 1800° C. The global buffer capacity is ½ mol O/mol V.

FIG. 6 illustrates the case of the Ga—O system:

The (Ga₂O₃/Ga) redox system of gallium is within the domain of predominance of the non-corrosive gases (in medium gray and light gray), over the entire temperature interval between 1000 and 2000° C. The (Ga₂O₃/Ga) system is active in the minimum gas zone at temperatures below 1500° C. The global buffer capacity is 3/2 mol O/mol Ga.

FIG. 7 illustrates the case of the Cr—O system:

The three chromium redox systems are rather in the reductive zone of the fuel functioning domain. The (CrO/Cr) system is active in the minimum gas zone at high temperatures (above 1750° C.). The CrO₍ₗ₎ phase appears at and above 1650° C. The global buffer capacity is 3/2 mol O/mol Cr.

FIG. 8 illustrates the case of the Nb—O system:

The Nb—O system is present in three different degrees of oxidation: +2, +4, +5 in the fuel functioning domain; the niobium redox systems (Nb₂O₅/NbO₂) and (NbO₂/NbO) are both in the domain of predominance of the non-corrosive gases (in medium gray and light gray), over the entire temperature interval between 1000 and 2000° C. In addition, the (Nb₂O₅/NbO₂) buffer system is exclusively in the zone in which the gaseous fraction is minimal;

the maximum working buffer capacity is 3/2 mol O/mol Nb, the (Nb₂O₅/NbO₂) couple providing ½ mol O/mol Nb and the (NbO₂/NbO) couple providing 1 mol O/mol Nb;

the literature indicates that the niobium redox reactions are capable of being thermodynamically activated at and above a temperature of 1000° C.; as a result, the niobium redox buffers are particularly suitable for controlling the P_{O2} over the entire functioning temperature range of the fuel.

Example of a Process for Manufacturing Fuels of the Invention:

In general (but non-restrictively), the process for manufacturing the supplemented fuel tablets according to the invention may be broken down into the following steps:

1) mixing UO₂ powder with the powders constituting the buffer system by comilling or turbomixing, so as to produce an intimate mixture. The comilling may be performed dry or in liquid medium;

2) in the case of milling solely in a liquid medium: drying and then screening at 850 μm;

3) the addition of lubricant to facilitate the subsequent forming (0.2 to 0.5% m (by mass) of zinc stearate or of another lubricant);

4) mechanical granulation of the mixture by pressing at low pressure (50 to 100 MPa) followed by screening between 400 and 900 μm;

5) forming by high-pressure double-effect uniaxial pressing (between 300 and 700 MPa);

6) sintering under a reductive and/or neutral atmosphere at about 1700° C. The tablets are placed in a closed gondola, close to a sufficient amount of a mixture of the powders constituting the redox buffer used in the tablets. The purpose of this amount of buffer is to reduce the effect of the concentration gradient of buffer materials between the interior and exterior of the tablets. When it exists, this gradient may lead to the appearance of a peripheral zone in the pellets which has a microstructure different from that of the cortical zone.

Example of a Process for Manufacturing an Object Such as a Tablet Based on a Fuel of the Invention:

As regards the manufacture of raw (i.e. before sintering) objects (tablets), the protocol for manufacturing fuels comprising a buffer system may be based on the following sequence of steps:

the preparation of the tablets is performed according to a standard protocol of powder metallurgy applied to the manufacture of the fuels, which comprises the steps described below:

1) mixing/milling of the UO₂ powders and of the buffer system in a planetary blender in the liquid phase (ethanol);

2) baking at 60° C. until the ethanol has fully evaporated off;

3) screening (850 microns);
4) granulation of the mixture at 80 MPa followed by crushing and screening at 850 microns;

5) pressing with a double-effect uniaxial press with lubrication of the matrix with zinc stearate spray. The pressure applied for manufacturing the two types of pellets is 400 MPa.

It should be noted that in order to estimate the amounts of dopant (buffer system) to be incorporated into the fuel, the fact that it is necessary to provide a buffer capacity of the order of 0.008 mol O/mol U both in oxidation and in reduction in order to absorb the effect, at 30 GWj/t.U of degree of combustion, may be used as a basis.

To destabilize the corrosive TeI₂ form generated by fission, it is necessary, for a degree of combustion of 30 GWj/t.U, to trap 0.008 mol O excess/initial U, i.e. 0.257 mol O/U fissioned.

The manufacture of the fuel doped with the abovementioned buffer systems is based on following the general protocol described previously.

An example of a sintering cycle is illustrated in FIG. 9, which shows a thermal program, the temperature of the final plateau possibly ranging typically between 1700 and 1800° C.

Example of Manufacture of a UO₂ Fuel Dosed with the Buffer NbO₂/NbO or Nb₂O₅/NbO₂:

The dimensioning of a UO₂ fuel doped with niobium is developed in detail below.

The calculation is performed on the basis of a stoichiometric UO₂, i.e.:

O/U=2.0.

If 1 mol of UO₂ is fissioned in a nuclear reactor, it is necessary to have available a minimum oxidizing buffer capacity of the order of 0.008 mol/mol U, i.e. 0.257 mol O/U fissioned in order for a fuel irradiated to 3.11% (i.e. about 30 GWj/t.U) to be maintained in the minimum gaseous phase zone.

This amount corresponds globally to that required to partially or totally reduce the oxidizing species Cs₂MoO₄, CeO₂ and MoO₂ generated by the fission of uranium (reduction of Cs₂MoO₄ to CsI, CeO₂ to Ce₂O₃ and excess MoO₂ to Mo) in order to impose a functioning potential of the fuel in the optimum domain defined in FIG. 2, ensuring total destabilization of the corrosive form TeI₂.

According to the reaction NbO₂+½O→NbO_{5/2}, at least 0.514 mol of NbO₂/mol of U fissioned is necessary to trap this excess oxygen. This makes 1.905 mol NbO₂/kg of UO₂ fissioned, i.e. the equivalent of 23.8% by weight of NbO₂/UO₂ fissioned.

If a degree of combustion of 50 GWj/t.U is targeted, it is necessary to introduce an amount of 1.19% NbO₂/UO₂. In reduction, the evolution of cesium is proportionately more retarded the greater the content of reducing element. There is therefore no minimum or maximum amount to be introduced. If an equimolar buffer system of oxidizing agent and reducing agent is targeted, 1.905 mol NbO_{5/2}/kg of UO₂ fissioned is calculated, i.e. the equivalent of 25.3% by weight of Nb₂O₅/UO₂ fissioned.

If a degree of combustion of 50 GWj/t.U % is targeted, it is necessary to introduce an amount of 1.27% Nb₂O₅/UO₂.

A buffer system composed of 1.27% by weight of Nb₂O₅/UO₂ and 1.19% by weight of NbO₂/UO₂ is thus calculated, i.e. a total amount equivalent to 2.58% by weight of Nb₂O₅/UO₂ for a degree of combustion of 50 GWj/t.U %.

The table below collates the dimensioning for the various niobium redox systems for a fuel with a degree of combustion of 50 GWj/t.U:

| | | | | Equivalent % |
|---|---|---|---|---|
| | NbO_{5/2} | NbO₂ | NbO | NbO_{5/2}/UO₂ |
| NbO_{5/2}/NbO₂ | | | | |
| % weight/UO₂ | 1.27 | 1.19 | | 2.53 |
| Mol/molUO₂ | 0.0257 | 0.0257 | | |
| For 1 kgUO₂ | 12.7 g | 11.9 g | | |
| NbO₂/NbO | | | | |
| % weight/UO₂ | | 0.60 | 0.52 | 1.27 |
| Mol/molUO₂ | | 0.0129 | 0.0129 | |
| For 1 kgUO₂ | | 6.0 g | 5.2 g | |
| Mixed system | | | | |
| % weight/UO₂ | 0.30 | 1.19 | | 1.57 |
| Mol/molUO₂ | 0.0061 | 0.0257 | | |
| For 1 kgUO₂ | 3.0 g | 11.9 g | | |

The mixed buffer corresponds to the dopant NbO₂ predominantly, which is capable of reacting both in oxidation ((NbO_{5/2}/NbO₂ redox system) and in reduction ((NbO₂/NbO) redox system). About 0.3% of Nb₂O₅ is added thereto so as to stabilize the oxygen potential and to generate a liquid phase during the manufacture in order to promote the growth of UO₂ grains.

If an over-stoichiometric UO₂ fuel is used to begin with, it is necessary to add an additional amount of reducing agent in order to compensate for the initial over-stoichiometry of the uranium oxide.

For the (NbO₂/NbO) buffer system, for example, according to the equation UO₂₊ₓ+xNbO [symbol] UO₂+xNbO₂, it is necessary to impose an initial mole ratio NbO/UO₂=x during the manufacture. To this amount is added that calculated above to buffer the oxygen potential in the reactor.

It is then possible to obtain a UO₂ microstructure doped with 3% of NbO₂/NbO with mean grain sizes of about 20 microns.

FIG. 10 represents schematically a sintering device (itself placed in an oven) for producing pellets containing the buffer system. More specifically and advantageously, the sintering operation is performed on the powder supplemented with redox species in the presence of external powder of this same redox species, making it possible to homogenize the P_{O2} in the oven and thus to improve the quality of the finished product. In the example illustrated in FIG. 10, the UO₂ powder supplemented with the NbO₂/NbO couple is placed in a molybdenum crucible with an additional NbO₂/NbO powder.

In general:

the proportions of the additive redox systems used in the present invention are less than 3% by mass, an excessive buffer content inducing modifications that are detrimental to the fuel with regard to its properties or behavior in reactors, and

the proportions of the additive redox systems are greater than 1%, an excessively low buffer capacity not making it possible to ensure control of the P_{O2}.

Preferentially, these proportions are greater than about 1.1% so as to be able to buffer the oxygen potential during functioning in a reactor, for targeted degrees of combustion of the order of 50 GWj/t.U and of the buffer systems under consideration.

Certain redox systems have, in effect, a higher buffer capacity than others, for example the maximum buffer capacity for the TiO₂/Ti₄O₇ system is ¼ mol of oxygen atom per mole of Ti supplied, whereas for the NbO₂/NbO system as described previously, it is 1 mol of oxygen per mole of Nb.

1. A supplemented nuclear fuel, comprising a nuclear fuel of oxide type which generates fission products such as tellurium, cesium and iodine, which generate via chemical interaction species that are potentially corrosive, supplemented with at least one redox system comprising a first and a second species comprising a common element having a different degree of oxidation in each of the two species, said system having an oxygen potential curve as a function of the temperature that is within an interval delimited by:
an upper limit: the curve of coexistence of the chemical species I₂Te (g) and CsI (g) at the same partial pressure imposed by the equilibrium between CsI (l) and CsI (g), approximated between 1000° C. and 2000° C. by a straight line segment whose ends P_{O2/11} and P_{O2/12} have the coordinates:
P_{O2/11} (T=1000° C.)≈−370 kJ/molO₂ and
P_{O2/12} (T=2000° C.)≈−230 kJ/molO₂; and
a lower limit: the curve of oxygen potential of the system (Cs₂MoO₄/Cs+Mo) approximated between 1000° C. and 2000° C. by a straight line segment whose ends P_{O2/21} and P_{O2/22} have the coordinates:
P_{O2/21} (T=1000° C.)≈−530 kJ/molO₂ and
P_{O2/22} (T=2000° C.)≈−390 kJ/molO₂.

2. The supplemented nuclear fuel as claimed in claim 1, wherein said system has a curve of oxygen potential as a function of the temperature located in an interval defined by a sub-domain delimited by:
an upper limit: the curve of coexistence of the chemical species Te₂ (g) and CsI (g) at the same partial pressure imposed by the equilibrium between CsI (l) and CsI (g), approximated between 1000° C. and 2000° C. by a straight line segment whose ends P_{O2/21′} and P_{O2/22′} have the coordinates:
P_{O2/11′} (T=1000° C.)≈−395 kJ/molO₂ and
P_{O2/12′} (T=2000° C.)≈−290 kJ/molO₂;
a lower limit: the curve of coexistence of the chemical species Cs (g) and CsI (g) at the same partial pressure imposed by the equilibrium between CsI (l) and CsI (g), approximated between 1000° C. and 2000° C. by a straight line segment whose ends P_{O2/21′} and P_{O2/22′} have the coordinates:
P_{O2/21′} (T=1000° C.)≈−480 kJ/molO₂ and
P_{O2/22′} (T=2000° C.)≈−360 kJ/molO₂,
said curves defining a sub-interval in which the gaseous fraction of the volatile gases generated by fission is both non-corrosive and minimal, for degrees of combustion of less than or equal to about 70 GWj/t.U and preferentially less than about 60 GWj/t.U (tons of uranium).

3. The supplemented nuclear fuel as claimed in claim 1, further comprising a sum of the mass percentage of first species and of the mass percentage of second species of between 1% and 3%.

4. The supplemented nuclear fuel as claimed in claim 1, further comprising a sum of the mass percentage of first species and of the mass percentage of second species of between 1.1% and 3%.

5. The supplemented nuclear fuel as claimed in claim 1, wherein at least one of the two species comprises an element derived from fission products that may be:
molybdenum, said system comprising a couple of the type: XMoO₄/XO where X belongs to the family of alkaline-earth metals (Ba, Ca, Sr);
barium, said system comprising the BaUO₄/BaO couple.

6. The supplemented nuclear fuel as claimed in claim 1, wherein the redox system comprises at least one of the following couples:
TiO₂/Ti₄O₇;
Ti₄O₇/Ti₃O₅;
V₂O₃/VO;
Ga₂O₃/Ga;
Cr₂O₃/Cr;
Cr₂O₃/CrO;
CrO/Cr;
NbO_{5/2}/NbO₂;
NbO₂/NbO;
NbO_{5/2}/NbO₂/NbO.

7. The nuclear fuel as claimed in claim 6, wherein the redox system comprises a mixed system based on NbO₂/NbO_{5/2}, the amount of NbO₂ being greater than the amount of NbO_{5/2}.

8. A fuel element comprising a nuclear fuel as claimed in claim 1 and cladding containing the nuclear fuel.

9. A process for manufacturing a tablet comprising the supplemented nuclear fuel as claimed in claim 1, further comprising the following steps:
a step of mixing the powders of fissible nuclear fuel that may be UO₂ and of the redox system;
a step of mechanical granulation of the mixture by pressing at low pressure which may be between about 50 MPa and 100 MPa;
a step of forming by pressing at a higher pressure that may be between about 300 MPa and 700 MPa;
a step of sintering under a reductive and/or neutral atmosphere at a temperature that may be about 1700° C.

10. The process for manufacturing a tablet comprising the supplemented nuclear fuel as claimed in claim 9, wherein the powder mixing step is performed by comilling in dry or liquid medium.

11. The process for manufacturing a tablet comprising the supplemented nuclear fuel as claimed in claim 9, wherein the powder mixing step is performed in a turbomixer.

12. The process for manufacturing a tablet comprising the supplemented nuclear fuel as claimed in claim 9, wherein the sintering step is performed with a temperature increase protocol comprising two temperature ramps separated by a temperature stage at about 300° C., followed by a stage at a maximum temperature of about 1700° C.

13. The process for manufacturing the tablet comprising the supplemented nuclear fuel as claimed in claim 9, wherein the sintering step is performed in an oven in the presence of an additional amount of redox system.

14. A process for manufacturing an element of a nuclear reactor fuel comprising cladding and a supplemented nuclear fuel, further comprising the process steps for manufacturing a tablet comprising said supplemented nuclear fuel as claimed in claim 9.
